(19) United States
(12) Patent Application Publication
(10) Pub. No.: US 2002/0022689 A1
(43) Pub. Date: Feb. 21, 2002

(54) Process for preparation of water soluble polypyrrole

(76) Inventors: Vinod P. Menon, Woodbury, MN (US); Patrick John Kinlen, Fenton, MO (US)

Correspondence Address: THOMPSON COBURN, LLP, ONE FIRSTAR PLAZA, SUITE 3500, ST LOUIS, MO, 63101, US

(21) Appl. No.: 09/929,191

(22) Filed: Aug. 14, 2001

Related U.S. Application Data
(60) Provisional application No. 60/225,194, filed on Aug. 14, 2000.

(51) Int. Cl. C08L 61/00

(52) U.S. Cl. 525/30

(57) ABSTRACT

A process for the preparation of water soluble polypyrrole is provided. The process comprises admixing pyrrole, water, and an effective amount of an electroinactive water soluble polycation to form an initial composition. That initial composition is admixed with an effective amount of an oxidizer to form a reacting composition, which is allowed to react for a time sufficient until substantially no decrease in potential occurs, whereby the polypyrrole is formed.

### CROSS-REFERENCE TO RELATED APPLICATIONS

This application claims priority under 35 U.S.C. 119(e) from U.S. Provisional Patent Application No. 60/225,194, filed Aug. 14, 2000, which is hereby incorporated by reference in its entirety.

### BACKGROUND OF THE INVENTION

Over the past two decades, the electronically conductive polymer polypyrrole has attracted a great deal of research due to its recognized unique electrical, electrochemical and optical properties. However, in spite of the extensive research efforts devoted to this polymer, commercial applications have been limited. One of the main obstacles has been the insolubility and intractability of this material which makes conventional methods of processing challenging or virtually impossible. Furthermore, environmental concerns have placed restrictions on the commercial use of certain organic solvents. This in turn has encouraged the use of polymers that can be processed in aqueous solutions which includes water soluble polypyrrole.

Polypyrrole has been the polymer of choice for biological applications of conductive polymers due to its ease of synthesis, oxidative stability and benign nature. Indeed, a recent study has shown that polypyrrole can be used to enhance nerve repair and is biocompatible. See, STIMULATION OF NEURITE OUTGROWTH USING AN ELECTRICALLY CONDUCTING POLYMER, Shastri, V. R., Vacanti, J. P., Schmidt, C., and Langer, R.; Proceedings of the Natural Academy of Sciences, 94: 8948-53, 1997, which is hereby incorporated by reference in its entirety.

Typically, such biological applications comprise biosensors (e.g., glucose sensors or DNA diagnostics), substrates for cell-growth (e.g. nerve cell regeneration), drug-delivery devices and artificial muscles.

### OBJECTS OF THE INVENTION

It is an object of the invention to provide an improved process for the preparation of water soluble polypyrrole.

It is also an object of the invention to provide a water soluble polypyrrole having high electrical conductivity.

It is a further object of the invention to provide a powder form of the water-soluble polypyrrole that can be conveniently redissolved in water with adequate agitation.

It is another object of the invention to provide a water insoluble film cast from a water soluble polypyrrole.

It is yet a further object of the invention to provide a facile method for inserting a dopant of choice into the water-soluble polypyrrole matrix during synthesis.

These and other objects of the invention are further described in more detail in the description of the invention which follows.

### BRIEF SUMMARY OF THE INVENTION

This invention comprises a process for the preparation of a water soluble polypyrrole, which comprises admixing pyrrole, water, and an effective amount of an electroinactive water soluble polycation to form an initial composition. An effective amount of an oxidizer, which is compatible with said pyrrole is admixed with the initial composition over a sufficient time and temperature that is effective to form a reacting composition. This reacting composition can be used to determine the potential thereof. The reacting composition is then allowed to react for a time that is sufficient to form said polypyrrole without decreasing the potential.

The polypyrrole of this invention is preferably isolated as a powder form that can be redissolved in water to give an aqueous solution. The dopant ion formed initially on the polypyrrole can be easily exchanged through a simple acid-base aqueous transformation for the dopant of choice. Finally, a process is provided for casting water insoluble films from aqueous solutions of this inventive material.

Another embodiment of this invention comprises the use of homopolymers and copolymers of derivatives of pyrrole and copolymers of derivatives of pyrrole and pyrrole.

### BRIEF DESCRIPTION OF THE SEVERAL VIEWS OF THE DRAWINGS

FIGS. 1-5 show graphical data, which has been obtained from Examples 1-6 following hereinafter.

FIG. 1 shows the data from Example 2. It is a schematic of the reaction occurring during the synthesis.

FIG. 2 shows a plot of the recorded solution temperature and solution potential during the progress of the reaction. The conditions at the beginning of the experiment are as follows:

Temperature=0° C.; concentrations of reagents (w/w)=0.4% pyrrole, 1.33% polyquat, 0.03% ferrous sulfate, 2.4% hydrogen peroxide, and 0.2 M hydrochloric acid.

FIG. 3 illustrates the aqueous UV spectra of solubilized doped and undoped forms of the soluble polypyrrole.

FIG. 4 illustrates a dual plot of frequency change (Hz) and current (uA) measured simultaneously on applying a potential scan to a thin film of a blend of water-soluble polypyrrole and poly(vinyl alcohol) coated on a quartz crystal microbalance electrode.

FIGS. 5 and 6 show the data from Example 6. The data in FIG. 5 is for chloride doped polypyrrole as synthesized using material from Example 3. The data in FIG. 6 is for gibberellate doped polypyrrole as synthesized using material from Example 4.

### DETAILED DESCRIPTION OF THE INVENTION

A novel process has been invented, and is disclosed and claimed herein for economically synthesizing water-soluble polypyrrole having quaternary ammonium functionalities that exhibit a high level of conductivity. The polypyrrole of this invention is preferably isolated in powder form that can be redissolved in water to give aqueous solutions. Furthermore, the dopant ion in the charged form initially on the polypyrrole can be easily exchanged through a simple acid-base aqueous transformation for the dopant of choice. Finally, a process is provided for casting water insoluble films from aqueous solutions of this inventive material.

Illustrative non-limiting representative examples of water-soluble quaternary ammonium polymers useful in this invention are polydiallydimethylammonium salts, quaternized poly(2-vinyl-1-pyridinium) salts, quaternized poly(4-vinyl-1-pyridinium) salts, poly(2-hydroxy-3-methacryloxypropyltrimethylammonium) salts, poly(methacrylamidopropyltrimethylammonium salts), poly(4-vinylbenzyltrimethylammonium) salts, mixtures thereof and the like. Typically, all these salts are commercially available in the chloride form.

Poly(methacrylamidopropyltrimethylammonium) salts can be obtained from Monomer Polymer and Dajac Labs, 1675 Bustleton Pike, Feasterville, Pa. 19053. Other salts may be obtained from PolySciences Inc., 400 Valley Road, Warrington, Pa. 18976.

Illustrative polydiallydimethylammonium salts include those selected from the group consisting of organic and inorganic anions. Representative examples of organic anions are p-toluenesulfonate, benzenesulfonate, methanesulfonate and acetate. Representative examples of inorganic anions are chloride, tetrafluoroborate, hexafluorophosphate and fluorosulfonate. Additional examples of both classes of salts can be found in U.S. Pat. No. 5,281,363 to Shacklette, et al., Jan. 25, 1994 (hereinafter “the '363 patent”), and U.S. Pat. No. 5,911,918, to Shacklette, et al. Jun. 15, 1999 (hereinafter “the '918 patent”), which are incorporated herein by reference in their entireties. While the most commonly available salt form is the chloride form, it should be obvious to one skilled in the art that the chloride form can be exchanged for any one of the salts above by a simple process of ion-exchange. It should be appreciated that the same salts can be used for all the other polyquat examples.

Illustrative poly(2-vinylpyridinium) salts and poly(4-vinylpyridinium) salts include, but are not limited to poly(2-vinyl-1-methylpyridinium), poly(4-vinyl-1-methylpyridinium) salts, poly(methacrylamidopropyltrimethylammonium) salts, poly(2-hydroxy-3-methacryloxypropyltrimethylammonium) salts, and ply(4-vinylbenzyltrimethylammonium) salts.

Suitable anions that may be employed to provide such salts include, but are not limited to organic or inorganic anions. Organic ions that may be employed in this invention include, but are not limited to p-toluenesulfonate, benzenesulfonate, methanesulfonate and acetate. Inorganic anions useful in this invention include, but are not limited to bromide, chloride, tetrafluoroborate, hexafluorophosphate and fluorosulfonate.

Suitable pyrroles for this invention are commercially available in 98% pure liquid form from Aldrich Chemicals (Milwaukee, Wis. 53233).

The process of this invention is typically carried out at a pH in the range from about 0.1 to about 6, and more preferred from about 0.2 to about 2,with the most preferred pH being about 0.7. Those of skill in the art will recognize after reading this specification that higher and low pH levels may be employed if desired.

Typically, the concentration of pyrrole in the process of this invention is in the range from about 0.1% w/w to about 8% w/w, with a preferred range being about 2% w/w to about 6% w/w, and the most preferred concentration of about 4% w/w. Various concentrations may be usefully employed if desired. (w/w as employed herein means ratio on a weight basis).

Generally, the ratio of pyrrole to oxidant (equivalents) in the process of this invention is in the range from about 4/1 to about 1/4, with the preferred ratio of pyrrole to oxidant of about 2/1 to 1/3. The most preferred ratio is about 1/2.5. In accordance with the present invention, various mole ratios may be employed.

Oxidizers or oxidizing agents that may be usefully employed in carrying out this invention include, but are not limited to a substance or substances, which have the ability to oxidize pyrrole in the process of this invention. These oxidizing agents include, but are not limited to ferric salts, ceric salts, cupric salts, vanadium salts, persulfates, nitrosyl hexafluorophosphate, permanganate and dichromate in acid media, and hydrogen peroxide in acid media with a catalytic amount of redox metal salt.

Preferred oxidizers in the process of this invention include, but are not limited to hydrogen peroxide in acid media with a catalytic metal salt capable of at least two reversible oxidation states.

When ferrous salt is employed as an oxidizer in the process of this invention, typically the weight ratio of pyrrole to ferrous salt is in the range from about 500/1 to about 1000/1 with a preferred range being from about 300/1 to about 800/1 and the most preferred weight ratio being about 640/1.

Illustrative other salts, which may be employed include and are not limited to ceric and cupric salts.

Typically, the process of this invention is carried out at a temperature in the range from about 0° C. to about 25° C., with the preferred temperature in the range from about 2° C. to about 10° C. The most preferred temperature is about 4° C. Other temperatures may be employed to carry out the process of this invention if desired, depending on reaction conditions, etc.

Generally the weight ratio of pyrrole to quaternary ammonium polymer in the process of this invention is in the range from about 15/1 to about 1/10, with the preferred range from about 10/1 to about 5/1, and the most preferred being about 7.2/1. The weight ratio may be varied depending on other factors and reaction conditions.

The molecular weight of polyquat (Da) in the process of this invention is generally from about 5000 to about 500,000, with the most preferred from about 50,000 to about 400,000, and the most preferred being about 200,000. Lesser and greater molecular weights may be employed if desired, according to desired reaction conditions, as those of skill in the art will recognize after reading this specification.

A suitable solvent or combination thereof may be employed if desired in the removal and isolation of the water soluble polypyrrole of this invention. Suitable non-limiting solvents include those solvents such as acetone, isopropanol, acetonitrile, propylene carbonate, tetrahydrofuran, mixtures thereof and the like.

When acetone is employed as a solvent in the process of this invention to effect removal of the product polypyrrole from the reacting composition, the weight ratio of reaction composition to acetone is generally from about 1:1 to about 1:10, and the preferred range is from about 1:2 to about 1:5 with the most preferred about 1:3.

If desired, any non-solvent for the polyquat that is completely miscible with water can be used to precipitate the conducting interpolymer complex of polypyrrole and polyquat. Examples of such non-solvents include, but are not limited to acetone, isopropanol, acetonitrile, propylene carbonate, tetrahydrofuran, mixtures thereof and the like.

If desired, any water-soluble organic or mineral acid that can maintain the desired pH range can be used in the process of this invention. Examples of broad classes of acids are found in the Allied-Signal patents on polyanilines. See the '363 patent and the '918 patent.

Illustratively, acceptable organic acids useful in the process of this invention include, but are not limited to p-toluenesulfonic acid, methanesulfonic acid, trifluoromethanesulfonic acid, trifluoracetic acid, benzenesulfonic acid, acetic acid, mixtures thereof and the like.

Preferred acceptable organic acids include, but are not limited to p-toluenesulfonic acid, methanesulfonic acid, and trifluoromethanesulfonic acid.

Illustratively, acceptable mineral acids useful in the process of this invention include, but are not limited to hydrochloric acid, fluoboric acid, hexafluorophosphoric acid, fluorosulfonic acid, mixtures thereof and the like.

Preferred mineral acids useful herein include, but are not limited to hydrochloric acid and the like.

Strongly oxidizing acids such as nitric acid and the like should be avoided in the process of this invention.

Initial dopants that may be employed in preparing the water soluble polypyrrole of this invention include, but are not limited to chloride, p-toluenesulfonate, methanesulfonate and benzenesulfonate. Such initial type dopants are typically provided by their corresponding acids in the process of this invention.

Such initial dopants may be left on the polypyrrole of this invention, or may be exchanged and a product dopant placed on the polypyrrole of this invention. Typically product dopants include, but are not limited to agricultural actives such as growth regulators (gibberellic acid, indol acetic acid), herbicides (glyphosate, 3,6-dichloro-2-methoxybenzoic acid); pharmaceutical actives such as NSAID's (ibuprofen, naproxen), antibiotics (ampicillin, cephalothin), and gene therapeutics (DNA).

Preferred dopants useful herein include, but are not limited to biologically active anions such as gibberellate, DNA, ATP, indomethacin, ibuprofen, naproxen, ampicillin, cephalothin, cephalexin, sodium diclofenac, and sodium salicylate.

Means for providing, monitoring, or obtaining the potential of said reacting composition in the process of this invention include means that are suitable to provide the potential of said reacting composition to an observer and include, but are not limited to the ORP electrode.

The polypyrrole of this invention is preferably isolated in powder form that can be redissolved in water to give aqueous solutions. Furthermore, the dopant ion formed initially on the polypyrrole can be easily exchanged through a simple acid-base aqueous transformation for a dopant of choice. Finally, a process is provided for casting water insoluble films from aqueous solutions of this inventive material.

Water insoluble castings may be prepared according to this invention by combining 1% poly(vinyl alcohol) with 3% solubilized polypyrrole/polyquat complex. Water insoluble castings are employed in applications wherein the casting is in contact with aqueous media (e.g. drug delivery).

Casting can typically be carried out by spin-coating, dip-coating, or spray coating.

In carrying out the process of this invention, those of skill in the art will recognize that the reaction composition is placed in a condition to react by the suitable selection of a combination of reactants, temperatures and/or other conditions conducive to said reaction(s).

### EXAMPLES

EXAMPLES 1-6 are intended to merely provide detail about this invention and are not meant to limit this invention in any way. These Examples merely illustrate the invention and deviations from these Examples, which are within the scope of this invention, will be apparent to those of skill in the art after reading this specification and these Examples. All parts and percentages are by weight herein unless otherwise specified.

### Example 1

Synthesis of Water-soluble Polypyrrole

Water soluble polypyrrole of this invention was synthesized by polymerizing pyrrole in the presence of poly(diallyldimethylammonium chloride) (polyquat). Polyquat was obtained form Aldrich Chemicals. The interpolymer complex that is believed to form is highly water-soluble, can be cast as films, and is electronically conductive.

The reaction was carried out as follows:

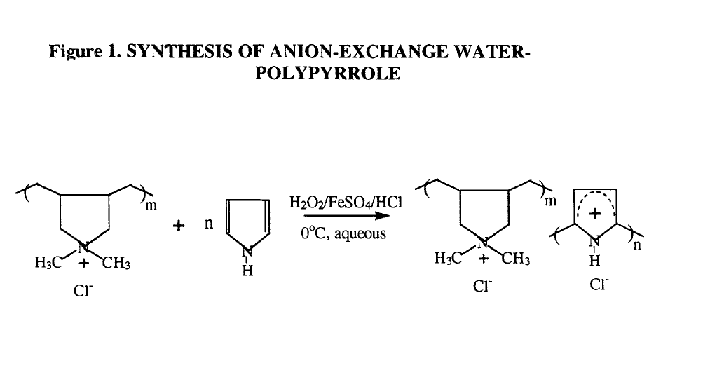

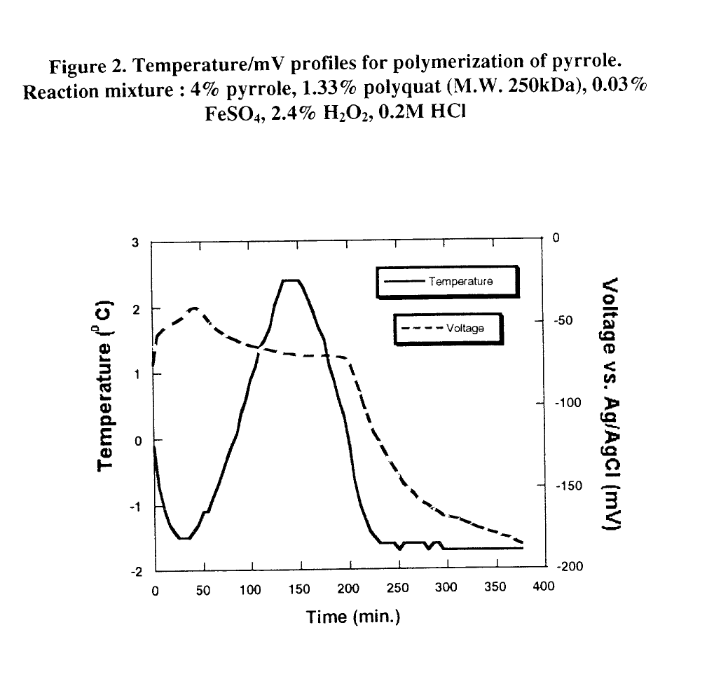

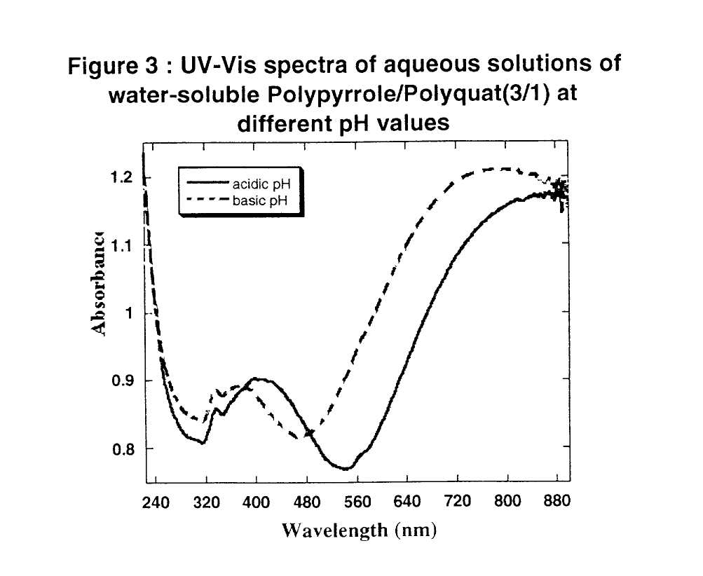

To 33.33 g of an aqueous solution of polyquat (20%, molecular weight 250-300 kDa from Aldrich Chemicals) was added sufficient water to bring the weight to 450 g. 10 g concentrated HCl (10M0 was added with stirring followed by 20 g pyrrole (both from Aldrich Chemicals). When all the pyrrole was dissolved, 0.13 g ferrous sulfate (Aldrich Chemicals) was added and the stirring continued. The solution was cooled to 0° C. and 40 g hydrogen peroxide (30% aqueous solution, Aldrich Chemicals) was added dropwise over a period of half an hour. The potential and voltage profiles were recorded as a function of time for the reaction (FIG. 1). An exotherm of 4° C. was observed after about 1.5 hours at which point the potential of the solution sharply dropped. The reaction was allowed to continue till there was no further drop in the potential (−8 hours). The reaction mixture was black in color but shows no sign of particles or precipitate. The solution was added with stirring to 1.5 liters of acetone (VWR Scientific, MacGraw Park, Ill.) when the polypyrrole precipitated out. The stirring was continued for 5 minutes and the mixture was then allowed to stand. When the precipitate settled down, the supernatant was decanted. 750 mL of acetone was added to the precipitate and the stirring and decanting repeated. The precipitate was then collected on a ceramic fritted funnel (40-60 microns) under vacuum and washed with two 750 mL lots of acetone. The powder was dried overnight under vacuum at room temperature. The yield of powder was 25.5 g (˜95% yield). The dopant in the polymer of this Example is chloride. Without being bound by theory, a postulated reaction schematic is shown in FIG. 2.

### Example 2

Solubilization of Water-soluble Polypyrrole Powder

The polymer from Example 1 above was resolubilized as follows: 0.45 g of powder of Example 1 was weighed out and 14.55 g of water was added to it to obtain a slurry containing 3% solids. The slurry was subjected to high shear in a Waring blender for 1 minute. This resulted in complete solubilization of the polymer, and the solution readily filtered through a 0.45 micron pore diameter polypropylene filter. Two-probe conductivity measurements of films cast from this solution reveal a conductivity of ca. 10⁻² S/cm.

### Example 3

Water-insoluble Coatings from Water-soluble Polypyrrole

The film cast from an aqueous solution of polypyrrole in Example 2 above can be redissolved by immersion in water. In order to cast water-insoluble films from this material, the 3% aqueous solution from example 2 was mixed with a sufficient volume of a 5% aqueous solution of polyvinyl alcohol (PVOH) (100% hydrolyzed, 86 kDa, Aldrich Chemicals) solubilized at 90 C. and cooled to room temperature to obtain a final concentration of 1% PVOH. The solution is filtered through a 0.45 micron filter. Films cast from this solution exhibit a conductivity of 10⁻³ S/cm. When this film was immersed in water, some swelling of the film was observed, but the film did not dissolve.

### Example 4

Replacement of Chloride Dopant with Gibberellate Anion in the Water Soluble Polypyrrole

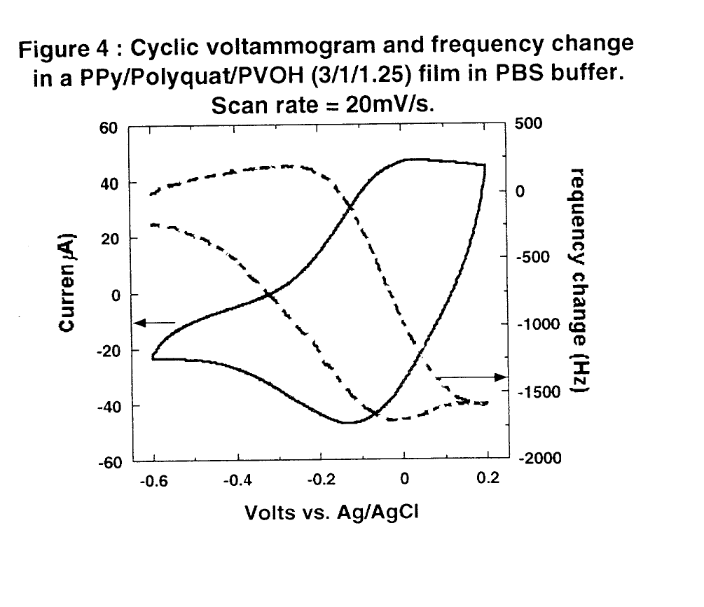

The water soluble polypyrrole was slurried in 0.01M tetraethylammonium hydroxide (Aldrich Chemicals) in isopropanol and the slurry stirred at room temperature for 10 minutes. An equal volume of acetone was then added to the mixture and the slurry filtered under vacuum. The resulting powder was washed in isopropanol/acetone two more times followed by a final wash in acetone. The powder was dried under vacuum overnight at room temperature. A 3% solution was prepared in water using the procedure in Example 2. The pH of this solution was ca. 10. Thin films cast from this solution exhibit a conductivity of 10-5 S/cm, indicating undoping of the polymer. Furthermore, the undoped form of polymer shows a spectral shift in the visible region relative to the doped form (FIG. 3). To this solution, sufficient gibberellic acid (a biologically important weak acid, Aldrich Chemicals) was added to obtain a pyrrole/GA molar ratio of four. The solution was stirred overnight at room temperature. To this solution was added sufficient amount of a 5% solution of polyvinyl alcohol (PVOH) (100% hydrolyzed, 86 kDa) to obtain a final concentration of 1% PVOH (polyvinyl alcohol). The solution was filtered through a 0.45 micron filter. Films cast from this solution exhibited a conductivity of 10⁻³ to 10⁻⁵ S/cm. (S/cm=ohm⁻¹cm⁻¹))

### Example 5

Electrochemical Release of Dopant from Films Cast from Water-soluble Polypyrrole

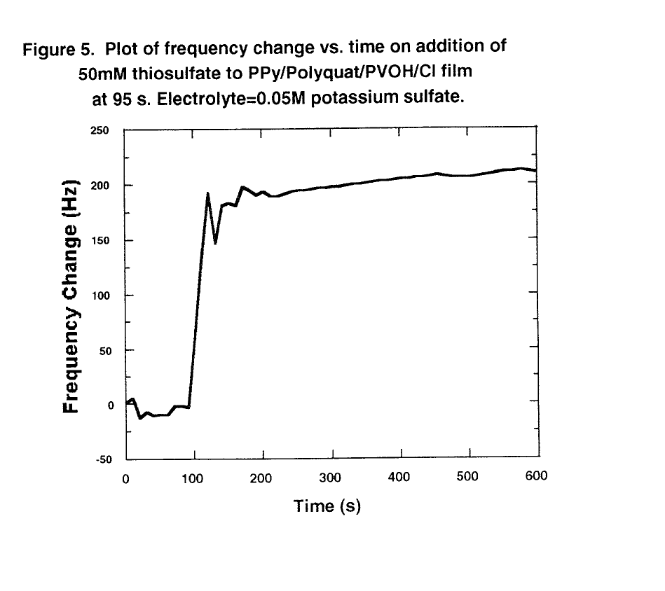

The solution from example 3 was used to cast a thin film on a quartz-crystal microbalance electrode (Quartz Crystal Analyzer QCA917 from Seiko EG&G hooked up to a Model 283 potentiostat from PAR EG&G). The frequency of the film-coated quartz crystal was monitored in a solution of phosphate-buffered saline (ph=7.2). When the frequency stabilized, the film was cycled between 0.2V and −0.6 vs. Ag/AgCl (FIG. 4). On oxidation of the polypyrrole, the mass of the film increased (frequency decreased) corresponding to charge compensation by insertion of anion. On reduction, the reverse happened and the anion was expelled from the film. This conclusively demonstrates the anion-exchange behavior of the water-soluble polypyrrole.

### Example 6

Chemical Release of Dopant from Films Cast from Water Soluble Polypyrrole

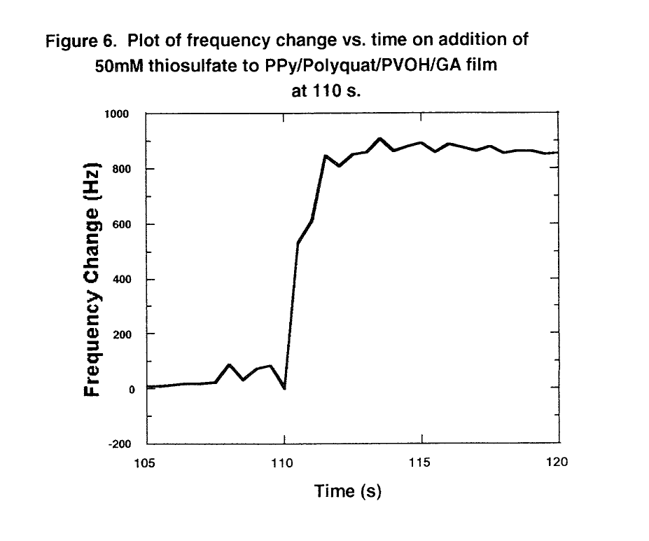

The solution from Example 3 above was used to cast a thin film on a quartz-crystal microbalance electrode. The frequency of the film-coated quartz crystal was monitored in a solution of 50 mM potassium sulfate (FIG. 5). When the frequency stabilized, the solution was spiked with 50 mM sodium thiosulfate. The frequency of the crystal immediately increased corresponding to release of dopant into solution. A similar result was obtained using Ppy film cast from solution in Example 4. These examples demonstrate feasibility of controlled release of dopant anion from water-soluble polypyrrole films by triggering with a chemical reducing agent.

The water-soluble polymer should have quaternary ammonium functionalities in order to be inert to oxidation. Secondary and tertiary amines can take part in the oxidative process and end up being covalently linked to the pyrrole.

Those of skill in the art will recognize after reading this specification that a combination of ferrous sulfate and hydrogen peroxide may be employed as a suitable oxidizing system here.

The amount of ferrous sulfate employed is in the range from about 0.05 to about 0.5 g, and preferably from about 0.1 to about 0.15 g.

The amount of hydrogen peroxide employed is in the range from about 30 to about 50 g, and preferably from about 35 to about 45 grams.

If employed, the pyrrole, acid, polyquat, and ferrous sulfate are added to the reaction mixture of this invention in any order. However, the hydrogen peroxide is always added last to the reaction mixture.

The dopant of this invention may be delivered to a receptor location by a process, which comprises casting a water-insoluble film of the polypyrrole/dopant combination on a substrate, making electrical contact with the film, and applying a current pulse of intensity and duration sufficient to dose the required amount of dopant. Alternatively, release may be effected by treating the film with a redox chemical having a reduction potential sufficient to convert the polypyrrole to its undoped state thereby releasing the dopant.

Typical receptor locations include, but are not limited to the outer coat of plant seeds (in agricultural seed coating applications); blood serum (transdermal and subcutaneous applications), and implanted scaffolds (for cell regrowth such as nerve regeneration).

In accordance with the instant invention, a process that fully satisfies the objects and advantages set forth herein above has been provided. While the invention has been described with respect to various specific examples and embodiments thereof, it is understood that the invention is not limited thereto and many alternatives, modifications and variations will be apparent to those skilled in the art in light of the foregoing description. Accordingly, it is intended to embrace all such alternatives, modifications and variations as fall within the spirit and broad scope of the invention.

What is claimed is:

1. A process for the preparation of water soluble polypyrrole comprising admixing pyrrole, water, and an effective amount of an electroinactive water soluble polycation to form an initial composition, admixing said initial composition with an effective amount of an oxidizer compatible with said pyrrole over a sufficient time and temperature effective to form a reacting composition so as to determine the potential thereof, and allowing said reacting composition to react for a time sufficient until substantially no decrease in potential occurs, whereby said soluble polypyrrole is formed.

2. The process of claim 1 wherein said initial composition is cooled to a temperature in the range from about 0° C. to about 25° C.

3. The process of claim 1 where said polypyrrole formed is removed from said reacted composition.

4. The process of claim 1 wherein said admixing is carried out in a controlled manner.

5. The process of claim 1 wherein an oxidizing agent is admixed in said initial composition.

6. The process of claim 1 wherein said electroinactive water soluble polycation is a quaternary cation.

7. The process of claim 6 wherein said polycation comprises one or more polydiallydimethylammonium salts.

8. The process of claim 7 wherein said polydiallydimethylammonium salts are selected from a group of organic and inorganic and inorganic anions and acetate and inorganic anions consisting of p-toluenesulfonate, benzenesulfonate, methanesulfonate, bromide, chloride, tetrafluoroborate, hexafluorophosphate and fluorosulfonate.

9. The process of claim 6 wherein said polycation comprises one or more poly(2-vinylpyridinium)salts.

10. The process of claim 9 wherein said poly (2-vinylpyridinium) salts are selected from a group of organic and inorganic anions consisting of p-toluenesulfonate, benzenesulfonate, methanesulfonate, acetate, bromide, chloride, tetrafluoroborate, hexafluorophosphate, fluorosulfonate, and the like.

11. The process of claim 6 wherein said polycation comprises one or more poly (4-vinylpyridinium) salts.

12. The process of claim 11 wherein said poly(4-vinylpyridinium)salts are selected from a group consisting of 1-methyl-4-vinyl-pyridinium trifluoromethane sulfonate, poly(4-vinyl-1-pyridinium) salts, poly(methacrylamidopropyltrimethylammonium salts), poly(4-vinylbenzyltrimethylammonium, and the like.

13. The process of claim 1 wherein said step of admixing pyrrole and water is at a pH in the range of about 0.1 to about 6.

14. The process of claim 13 wherein said pH is in the range from about 0.2 to about 2.

15. The process of claim 1 having a concentration of pyrrole to anion from about 0.1% w/w to about 8% w/w.

16. The process of claim 15 wherein said concentration is from about 2% w/w to about 6% w/w.

17. The process of claim 16 having a ratio of pyrrole to oxidant in equivalents of about 4/1 to about 1/4.

18. The process of claim 17 wherein said ratio is in the range from about 2/1 to about 1/3.

19. The process of claim 1 having a weight ratio of said pyrrole to said water soluble polycation from about 15/1 to about 1/10.

20. The process of claim 19 wherein said ratio is from about 10/1 to about 1/10.

21. The process of claim 1 wherein the water soluble polycation is a quaternary ammonium polymer.

22. The process of claim 21 wherein said quaternary ammonium polymer has a molecular weight in the range from about 5000 to about 500,000.

23. The process of claim 22 wherein said quaternary ammonium polymer has a molecular weight in the range from about 50,000 to about 400,000.

24. The process of claim 3 wherein the removal of water soluble polypyrrole from said reacted composition is accomplished by admixing acetone to said reacted composition.

25. The process of claim 24 having a ratio of reaction composition to said acetone in the range from about 1/1 to about 1/10.

26. The process of claim 25 wherein said ratio is in the range from about 1/2 to about 1/5.

27. The process of claim 1 wherein the water soluble polypyrrole formed has an electrical conductivity in the range from about 10⁰ to about 10⁻⁵ S/cm.

28. The water soluble polypyrrole of claim 27 wherein said electrical conductivity is in the range from about 10⁻¹ to about 10⁻⁴ S/cm.

29. The process of claim 1 wherein said water soluble polypyrrole is in powder form.

30. The process of claim 29 wherein said powder form can be redissolved in water with agitation.

31. The process of claim 3 wherein the water soluble polypyrrole in powder form.

32. The process of claim 31 wherein said powder form can be redissolved in water with agitation.

33. A water soluble copolymer of pyrrole, or derivatives thereof, prepared by the process of claim 1.

34. A water soluble copolymer of homopolymer of substituted pyrrole, or derivatives thereof, prepared by the process of claim 2.

35. A water soluble copolymer of polypyrrole prepared by the process of claim 3.

36. A water soluble copolymer of polypyrrole having an electrical conductivity in the range from about 10⁰ to about 10⁻⁵ S/cm.

37. The water soluble copolymer of polypyrrole of claim 32 wherein said electrical conductivity is in the range from about 10⁻¹ to about 10⁻⁴ S/cm.

38. A process for exchanging a dopant on a water soluble polypyrrole having an electrical conductivity in the range from about 10⁻⁸ S/cm to about 10⁰ S/cm.

39. The process of claim 34 wherein said polypyrrole has an electrical conductivity from about 10⁻⁴ S/cm to about 10⁻¹ S/cm.

40. The process of claim 33 wherein the water soluble polypyrrole is in powder form.

41. The process of claim 35 wherein the water soluble polypyrrole is in powder form.

42. The process of claim 40 wherein said powder form can be conveniently redissolved in water with adequate agitation.

43. An article of manufacture comprising a water soluble polypyrrole having an electrical conductivity in the range from about 10⁻⁸ S/cm to about 10⁰ S/cm and a bound dopant anion.

44. The article of manufacture of claim 43 wherein said polypyrrole has an electrical conductivity from about 10⁻⁴ S/cm to about 10⁻¹ S/cm.

45. A water soluble polypyrrole having an electrical conductivity in the range from about 10⁰ to about 10⁻⁵ S/cm.

46. The water soluble polypyrrole of claim 45 said electrical conductivity is in the range from about 10⁻¹ to about 10⁻⁴ S/cm.

47. The water soluble polypyrrole of claim 45 further comprising a copolymer.

48. The water soluble polypyrrole of claim 46 further comprising a copolymer.

49. A process for making a water insoluble film cast for a water soluble polypyrrole comprising solubilizing a polypyrrole/polyquat complex with polyvinyl alcohol at a temperature of about 90 C., cooling to about room temperature, and then filtering through a filter.

50. The process of claim 49 wherein the poly(vinyl alcohol) is 100% hydrolyzed.

51. The process of claim 49 wherein the polyvinyl alcohol is about 1% solubilized once the temperature becomes about room temperature.

52. The process of claim 50 wherein the polyvinyl alcohol is about 1% solubilized once the temperature becomes about room temperature.

53. The process of claim 49 wherein the filter is about a 0.45 micron filter.

54. The process of claim 49 wherein the films cast exhibit a conductivity of 10-3 S/cm.

55. The process of claim 49 wherein the solubilized polypyrrole/polyquat complex is 3% solubilized.

56. The process of claim 49 wherein the poly(vinyl alcohol) is applied to the polypyrrole/polyquat complex by spin coating, dip coating, or spray coating.

57. An article of manufacture created by solubilizing a polypyrrole/polyquat complex with polyvinyl alcohol at a temperature of about 90 C., cooling to about room temperature, and then filtering through a filter.

58. The article of manufacture of claim 57 wherein the poly(vinyl alcohol) is 100% hydrolyzed.

59. The article of manufacture of claim 57 wherein the polyvinyl alcohol is about 1% solubilized once the temperature becomes about room temperature.

60. The article of manufacture of claim 58 wherein the polyvinyl alcohol is about 1% solubilized once the temperature becomes about room temperature.

61. The article of manufacture of claim 57 wherein the filter is about a 0.45 micron filter.

62. The article of manufacture of claim 57 wherein the films cast exhibit a conductivity of about 10-3 S/cm.

63. The article of manufacture of claim 57 wherein the solubilized polypyrrole/polyquat complex is 3% solubilized.

64. The article of manufacture of claim 57 wherein the poly(vinyl alcohol) is applied to the polypyrrole/polyquat complex by spin coating, dip coating, or spray coating.

65. The article of manufacture of claim 59 wherein the polypyrrole/polyquat complex is 3% solubilized.

66. A process for inserting a dopant of choice into a water-soluble polypyrrole matrix during synthesis comprising:
a.) mixing, with stirring, tetraethylammonium hydroxide to isopropanol to form a slurry, adding an equal volume of acetone to said slurry, filtering said slurry under a vacuum to obtain a resulting powder, said resulting powder is then washed and dried;
b.) said washed and dried resulting powder is then resolubilized to form about a 3% solution;
c.) an acid containing an anion to be incorporated into the polymer is then added to said about 3% solution, stirring overnight at room temperature, adding a sufficient amount of polyvinyl alcohol and then filtering this product solution.

67. The process of claim 66 wherein the mixing, with stirring, of tetraethylammonium hydroxide to isopropanol occurs for about ten minutes.

68. The process of claim 66 wherein the resulting powder is washed in isopropanol/acetone two times followed by a final wash in acetone.

69. The process of claims 66 wherein the resulting powder is dried overnight on a vacuum at about room temperature.

70. The process of claim 66 wherein the pH of said 3% solution was about 10.

71. The process of claim 66 wherein the thin films cast from said 3% solution exhibit a conductivity of 10⁻⁵ S/cm.

72. The process of claim 66 wherein the ratio of pyrrole to anion is about 4 to about 1.

73. The process of claim 66 wherein the polyvinyl alcohol is a 5% solution of 100% hydrolyzed polyvinyl alcohol, 86 kDa, and a sufficient amount is added to obtain a final concentration of 1% polyvinyl alcohol.

74. The process of claim 66 wherein said product solution is filtered through about a 0.45 micron filter

75. The process of claim 66 wherein the films cast from said product solution after filtering and drying exhibit a conductivity of 10⁻³ to 10⁻⁵ S/cm.

76. The process of claim 68 wherein the resulting powder is dried overnight on a vacuum at about room temperature.
